(19) United States
(12) Patent Application Publication
(10) Pub. No.: US 2016/0380778 A1
(43) Pub. Date: Dec. 29, 2016

(54) A Master Device and Methods Therein

(71) Applicant: TELEFONAKTIEBOLAGET LM ERICSSON (PUBL), Stockholm (SE)

(72) Inventors: Wei Shen, Linköping (SE); Piergiuseppe di Marco, Sollentuna (SE); Per Elmdahl, Linköping (SE); Jingcheng Zhang, Norrköping (SE)

(21) Appl. No.: 14/893,382

(22) PCT Filed: Nov. 6, 2015
(86) PCT No.: PCT/SE2015/051179

§ 371 Date: Nov. 23, 2015

Related U.S. Application Data
(60) Provisional application No. 62/120,920, filed on Feb. 26, 2015.

(51) Int. Cl. H04L 12/18; H04L 29/08; H04L 12/26; H04L 12/911

(52) U.S. Cl. CPC H04L 12/189; H04L 47/781; H04L 67/28; H04L 43/08; H04L 43/16; H04W 4/008

(57) ABSTRACT

A master device 103 and a method for transmitting a message towards a destination node. The master and the destination are operating in a network 100. The master has a Slave Neighbour Table (SNT) and a Master Neighbour Table (MNT). When the identity of the destination is comprised in the SNT, the master unicasts the message to the slave having the same identity as the destination, otherwise the master determines if the identity of the destination is in the MNT. If so, the master unicasts the message to the neighbour master having the same identity as the destination or to the neighbour master being the master of the neighbour slave having the same identity as the destination; otherwise the master multicasts the message to all neighbour masters comprised in the MNT. When the identity is neither comprised in the SNT nor in the MNT, the master broadcasts the message.

### TECHNICAL FIELD

Embodiments herein relate generally to a master device and to methods therein. Especially, embodiments herein relate to transmitting a message towards a destination node.

### BACKGROUND

Bluetooth Low Energy (BLE) technology is an ultra-low power short-range radio technology providing a single-hop connectivity in a communications network. In general, a wireless mesh network is a network built on a number of fixed devices, e.g. stationary devices, and on a number of mobile devices that provide a robust and multi-hop communication for peer-to-peer transmissions. In a multi-hop wireless network, there are one or more intermediate nodes along the path that receive and forward packets via wireless links. However, the BLE technology inherently does not support such multi-hop mesh networking. There are some constraints for BLE in terms of coverage of the network, the transmission range and peer-to-peer communications. Mesh networking technology can promote the BLE technology to apply in even wider range of use scenarios.

The essential features of the BLE technology determine that its mesh networking will be different from other short-range technologies. There are two types of channels in existing BLE specifications: advertisement channels and data channels. In order to leverage data channels, each link in the network should have procedures comprising advertisement scanning, connection creation and establishment. Using data packets in data channels for mesh will significantly increase maintenance cost and latency. Therefore, in practice most existing proprietary solutions realise mesh communication using broadcast packets over advertisement channels. An alternative way has been presented, wherein a combination of advertisement channels and isochronous channels are used. However, that is not in compliance with the existing BLE specifications.

When it comes to forwarding algorithms, two simple methods are flooding and flooding with damming methods. In a flooding method every incoming message is sent out on every possible outbound link if the destination of the message is not reached. Further, in a flooding with damming method, some measures are taken to damp the effects of the flooding method that generates infinite number of messages. Some examples of flooding with damming methods comprise decrementing a hop counter at each hop to avoid infinitely processing the flooding, this is sometimes referred to as hop-to-live; sequence numbers together with a source to keep track of flooded packets to avoid repeating; and/or controlling sending rate at each device using proper algorithms.

Advantages with flooding-based methods are the simplicity, that no routing tables need to be stored and that there is no need to adapt to topology changes.

### SUMMARY

An object of embodiments herein is to overcome one or more drawbacks with the prior art and to improve the performance in a communications network, e.g. a wireless communications network, such as a mesh network. For example, some embodiments herein provide for lifetime optimization of the communications network.

According to a first aspect of embodiments herein, the object is achieved by a method performed by a master device for transmitting a message towards a destination node. The master device and the destination node are operating in a wireless communications network. The master device has a Slave Neighbour Table (SNT) configured to comprise information relating to a slave device, and a Master Neighbour Table (MNT) configured to comprise information relating to a neighbour master device and information relating to a neighbour slave device of the neighbour master device.

The master device determines if an identity of the destination node is comprised in the SNT.

When the identity of the destination node is comprised in the SNT, the master device unicasts the message to the slave device comprised in the SNT and having the same identity as the destination node, otherwise the master device determines if the identity of the destination node is in the MNT.

When the identity of the destination node is comprised in the MNT, the master device unicasts the message to the neighbour master device having the same identity as the destination node or to the neighbour master device being the master device of the neighbour slave device having the same identity as the destination node; otherwise the master device multicasts the message to all neighbour master devices comprised in the MNT.

When the identity of the destination node is neither comprised in the SNT nor in the MNT, the master device broadcasts the message.

According to a second aspect of embodiments herein, the object is achieved by a master device for transmitting a message towards a destination node. The master device and the destination node are operating in a wireless communications network. The master device has a Slave Neighbour Table (SNT) configured to comprise information relating to a slave device, and a Master Neighbour Table (MNT) configured to comprise information relating to a neighbour master device and information relating to a neighbour slave device of the neighbour master device.

The master device is configured to determine if an identity of the destination node is comprised in the SNT.

When the identity of the destination node is comprised in the SNT, the master device is configured to unicast the message to the slave device comprised in the SNT and having the same identity as the destination node, otherwise the master device is configured to determine if the identity of the destination node is in the MNT.

When the identity of the destination node is comprised in the MNT, the master device is configured to unicast the message to the neighbour master device having the same identity as the destination node or to the neighbour master device being the master device of the neighbour slave device having the same identity as the destination node; otherwise the master device is configured to multicast the message to all neighbour master devices comprised in the MNT.

When the identity of the destination node is neither comprised in the SNT nor in the MNT, the master device is configured to broadcast the message.

According to a third aspect of embodiments herein, the object is achieved by a computer program, comprising instructions which, when executed on at least one processor, causes the at least one processor to carry out the method performed by the master device.

According to a fourth aspect of embodiments herein, the object is achieved by a carrier comprising the computer program, wherein the carrier is one of an electronic signal, an optical signal, a radio signal or a computer readable storage medium.

Since the master device determines whether or not the destination node is comprised in the SNT and/or the MNT before transmitting a message destined to the destination node to one or more slave devices and/or to one or more neighbour master devcies, the signalling in the communications system is reduced. Thereby, the resources required for providing the signalling, e.g. power supply resources and/or memory resources, are reduced. This results in an improved performance in the wireless communications system since that the lifetime of network devices having constraints in for example the power supply is extended.

Some advantages of some embodiments will now be described.

Firstly, as mentioned above, an extension of the network lifetime may be provided. Battery powered devices, e.g. slave devices, are not required to keep listening to the communication channel(s) for messages, since non-battery powered and stationary devices, e.g. master devices, are preferred to relay messages in the network, e.g. the mesh network. The lifetime of the whole mesh network is thereby extended.

Secondly, low latency, high reliability and high network throughput may be provided. By the term low latency when used herein is meant that the end-to-end message latency should be achieved according to an application requirement, e.g. the latency should be less than the response time observed users for lighting case. Further, by the term high reliability when used herein is meant that the end-to-end message delivery rate should be achieved according to the application requirement. In some embodiments herein, it is proposed a forwarding scheme with an aim to utilize the advantages of flooding with damming methods and routing path optimization. Flooding with damming methods does not need time for adapting topology change due to devices in motion. Low latency may be achieved by leveraging flooding based forwarding method. The forwarding method of the routing path optimization is performed in stationary devices, while the flooding forwarding method is mainly performed associating with devices in motion and when the optimized routing paths are not feasible. Thus, reliability and high network throughput shall be achieved.

Thirdly, extensibility, flexibility and compatibility may be provided. By the term extensibility when used herein is meant that advanced specific routing optimization algorithms and flooding damming methods may be further developed based on the proposed scheme. Further, by the term flexibility when used herein is meant that some embodiments herein may be implemented in a combination of data channels and advertisement channels or in advertisement channels only. Furthermore, by the term compatibility when used herein is meant that embodiments of methods described herein do not require making any changes in existing BLE specifications. Some embodiments herein, provides a selection scheme between flooding and routing path optimization forwarding methods. Specific routing optimization algorithms and flooding damming methods may be further developed based on the proposed scheme. The proposed solution does not require making any changes in existing BLE specifications. The proposed technique may be implemented in a combination of data channels and advertisement channels or advertisement channels only.

Fourthly, an easy and simple installation is provided. Installation of devices, e.g. of communication devices operating in the network, may be performed by end users without any training.

### BRIEF DESCRIPTION OF DRAWINGS

Examples of embodiments herein are described in more detail with reference to attached drawings in which:

FIG. 1 schematically illustrates embodiments of a communications network;

FIG. 2 schematically illustrates embodiments of a Master Neighbor Table (MNT) of a communication device, e.g. a master device;

FIG. 3 schematically illustrates embodiments of a Slave Neighbor Table (SNT) of a communication device, e.g. a master device;

FIG. 4A is a flowchart schematically illustrating embodiments of a method in a communication device, e.g. a master device;

FIG. 4B is a flowchart schematically illustrating embodiments of a method in a communication device, e.g. a master device;

FIG. 5 is a flowchart schematically illustrating embodiments of a method in a first asymmetric device, e.g. a master device;

FIG. 6 is a block diagram schematically illustrating embodiments of a first asymmetric device, e.g. a master device;

FIG. 7 is a flowchart schematically illustrating embodiments of a method in a second asymmetric device, e.g. a slave device; and

FIG. 8 is a block diagram schematically illustrating embodiments of a second asymmetric device, e.g. a slave device.

### DETAILED DESCRIPTION

As part of developing embodiments herein, some problems with the state of the art wireless communications systems will first be identified and discussed.

Theoretically, flooding or flooding with damming methods choose every possible path (including shortest path) in parallel so as to increase reliability and produce low latency under ultra-low traffic rate. Reliability and latency become critical for a market success when it comes to the response time observed by users. Besides, a flooding method may be beneficial for memory-constraint devices since there is no need to maintain routing tables. By the term memory-constraint devices when used herein is meant devices that have a small-size memory, such as an 8 KB Random Access Memory (RAM) or a 256 KB flash memory just to give two examples. Further, the flooding method does not need time for adapting topology change due to devices in motion. Furthermore, the flooding method is also easy to install and setup, which is critical for many applications such as home automation applications because typical installation and setup are not performed by trained persons. In this sense, the flooding method outperforms routing path-optimization algorithms.

However, flooding or flooding with damming methods produce vast packets overhead, which increases network congestion and interference. In practical, flooding deteriorates the throughput in bandwidth-constrained channels, such as BLE advertisement channels, which, in turn, decreases the reliability and increases the latency.

Further, flooding requires all devices operating in the network to keep listening to the physical channel(s) as it may be broadcasting messages transmitted over the mesh network. This brings a big challenge for operating a flooding based mesh network on power-constrained devices. The power sources of BLE devices mainly comprise battery power sources and non-battery power sources. Some examples of non-battery power sources are grid power sources, main power sources, and energy-harvesting power sources. Battery-powered devices are required to operate for a long term, e.g., several years.

In order to overcome one or more drawbacks with the prior art some embodiments herein propose a mesh topology for a BLE mesh network comprising communication devices, such as asymmetric devices: e.g. one or more master devices, herein also referred to as Mesh Masters, and one or more slave devices, herein also referred to as Mesh Slaves. The master device is a non-battery powered and stationary device, and the slave device is a battery-powered device. In embodiments herein the master device takes more responsibility to relay messages in the network than the slave device. Therefore, battery-powered devices, e.g. slave devices, may run for a long-life time, which, in turn, extends the lifetime of the whole BLE network. Under this asymmetric topology, a forwarding scheme is proposed with an aim to utilize the advantages of flooding with damming methods and routing path optimization. In this way, some embodiments herein may achieve considerable improvements in performance in terms of network lifetime, latency, reliability, adaption to mobility, and network throughput.

In this disclosure, a device comprised in an asymmetric network architecture is sometimes herein also referred to as an asymmetric device.

Some embodiments herein propose an asymmetric mesh network architecture comprising one or more grouped piconet devices and one or more out-of-piconet devices. In each piconet, non-battery powered and stationary devices, e.g. master devices, take more responsibility to relay messages than battery-powered devices, e.g. slave devices. Therefore, battery-powered devices, e.g. slave devices, may operate for a long-life time, which, in turn, extends the lifetime of the whole mesh network.

Further, in some embodiments, a hybrid forwarding scheme is proposed with an aim to utilize the advantages of flooding with damming methods and routing path optimization. In this way, some embodiments herein achieve an improvement in performance, e.g. a considerable improvement in performance, in terms of e.g. network lifetime, latency, reliability, adaption to mobility, and network throughput.

In order to overcome one or more drawbacks with the prior art, some embodiments herein relate to a method in an mesh network for network lifetime optimization between asymmetric devices, e.g. a first and a second asymmetric device, operating in the mesh network. Especially embodiments herein relate to network lifetime optimization between a master device and a slave device operating in the mesh network.

Some embodiments herein relate to a mesh network, e.g. a BLE mesh network, and to a forwarding scheme for communications in the network.

A goal for some embodiments described herein is to develop an effective technique for a mesh network, e.g. a BLE mesh network, in order to achieve improvements in performance in terms of network lifetime, latency, reliability and network throughput.

An asymmetric network architecture and a hybrid forwarding scheme are proposed in some embodiments herein in order to realize the goal by utilizing the advantages of flooding with damming methods and routing path optimization.

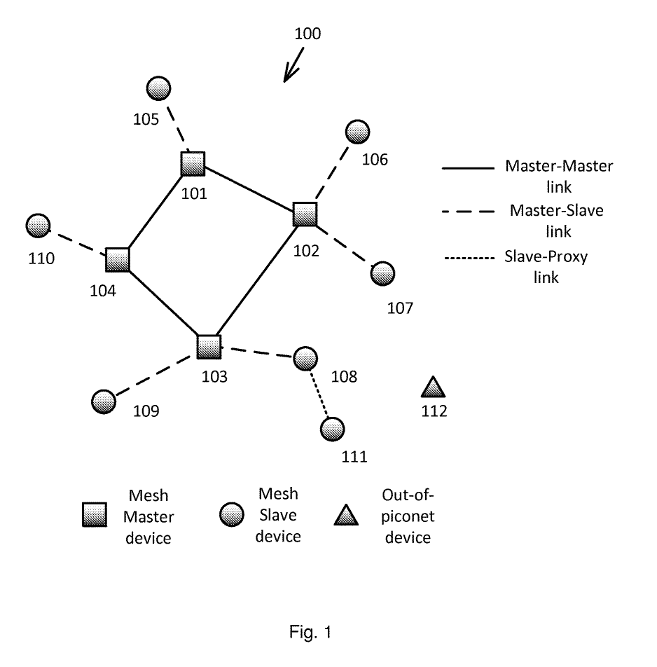

As schematically illustrated in FIG. 1, embodiments herein relate to a wireless communications network 100. The wireless communications network 100 may sometimes herein be referred to as a/the network, a/the mesh network, a/the BLE mesh network, and an/the asymmetric network but it may be any other wireless communication network or system.

A network node 101-112 may be comprised in or operating in the wireless communications network 100. The network node 101-112 may be a master node, e.g. a master device 101-104, a slave node, e.g. a slave device 105-111, or a node being neither a master node nor a slave node, e.g. an out-of-piconet device 112.

The network node 101-112 may also be referred to as a wireless device, device, mesh device, a user equipment or UE, operating in the wireless communications network 100. The wireless device may e.g. be a user equipment, a mobile terminal or a wireless terminal, a mobile phone, a computer such as e.g. a laptop, a Personal Digital Assistant (PDA) or a tablet computer, sometimes referred to as a surf plate, with wireless communication capability, or any other radio network units capable to communicate over a radio link in the wireless communications network 100. The wireless device may also be referred to as a Machine Type of Communication (MTC) device, an Internet of Things (IoT) device, e.g. a Cellular IoT (CIoT) device. Please note the term user equipment used in this document also covers other wireless devices such as Machine to Machine (M2M) devices, even though they do not have any user.

### Asymmetric Mesh Architecture

Some embodiments herein comprise an asymmetric network architecture, wherein a building block is a piconet.

When used herein the term piconet refers to a computer network which links a wireless group of devices, e.g. a group of wireless devices, using Bluetooth technology protocols. The piconet comprises two or more devices, e.g., one master device and one or more slave devices. The master and slave devices may be synchronized to a common clock and hopping sequence. The two or more devices comprised in the piconet may be one or more cellular devices connected to a computerised device such as a computer. The cellular device is any device configured to operate in a cellular network. Further, the two or more devices may be one or more computerised devices, such as laptops. Furthermore, the two or more devices may be a Bluetooth-enabled digital camera, or several PDAs that are connected to each other. It should be understood, that the piconet may comprise several devices of different kind.

In a piconet, e.g. in an intra-piconet and/or an inter-piconet, the master device, sometimes herein also referred to as Mesh Master, establishes and maintains a direct reliable communication with one or more slave devices, sometimes herein also referred to as Mesh Slaves. A requirement for Mesh Masters is that they are stationary and non-battery powered. Slaves are usually battery powered devices.

Since a limited number of devices may be configured as Mesh Masters in realistic applications, a device may not find a Mesh Master among neighbouring nodes in the network. Therefore, a Mesh Slave in a piconet may act as a proxy for another device, e.g. another slave device, that is to join in the piconet. This Mesh Slave is therefore sometimes referred to as a Mesh Proxy Slave. Thereby, coverage is extended in a low-cost way by indirectly connecting sporadic slave devices as proxy slave devices to a master device instead of increasing the number of master devices. In some embodiments herein, a device which has a mobility feature may not be a proxy slave device. In spite of the proxy slave devices, isolated devices may exit which isolated devices may not be able to find a Mesh Master or a Mesh Proxy Slave. Such isolated devices are called out-of-piconet devices.

When used herein the terms first asymmetric device, master, master device, mesh master, and mesh master device are used interchangeable. Further, when used herein the terms second asymmetric device, slave, slave device, mesh slave, and mesh slave device are used interchangeable. Furthermore, when used herein the terms proxy, proxy device, mesh proxy, and mesh proxy device are used interchangeable. Yet further, the terms device, mesh device, wireless device and communication device are used interchangeable herein.

Some examples of master devices are light switches that may be physically connected to main power, TV, devices in heating, ventilation and air conditioning systems. Further, some examples of slave devices are window and/or door security sensor devices, key fobs, and doorbells.

FIG. 1 shows an embodiment of an exemplary network architecture comprising twelve wireless devices, 101-112. As schematically illustrated, three types of wireless devices are defined, wherein a square block represent a master device 101-104, e.g. a first master device 101, a second master device 102, a third master device 103, and a fourth master device 104. A circle block represents a slave device 105-111, e.g. a first slave device 105, a second slave device 106, a third slave device 107, a fourth slave device 108, a fifth slave device 109, a sixth slave device 110, and a seventh slave device 111. Further, a triangle represents an out-of-piconet device 112. Furthermore, a solid line represents a link between master devices, e.g. between the first master device 101 and the second master device 102, and is sometimes referred to as a Master-Master link. A dash line represents a link between a slave device and its master device, e.g. between the first slave device 105 and the first master device 101, and is sometimes referred to as a Master-Slave link. Further, a half dash line represents a link between a slave device and its proxy device, e.g. between the seventh slave device 111 and the fourth slave device 108 acting as a proxy device, and is sometimes referred to as a Slave-Proxy link.

Any device in a mesh network is able to act as a relay device to forward received messages in order to reach an end-to-end destination. However, a relay device has to keep listening to the physical channel(s) as often as it can in order to receive messages transmitted over the mesh network. In order to extend the network lifetime, master devices are configured to have higher duty circling than other devices operating in the mesh network. Thereby, the master devices may take more responsibility to relay messages than slave devices, e.g. battery-powered devices. Furthermore, considering that the slave devices may be very low cost, resource-constrained and battery-powered devices, the master device may be configured to store routing tables, to manage piconet timing, to manage the duty cycling of its slave devices and other complex things.

In this section, embodiments herein will be illustrated in more detail by a number of exemplary embodiments. It should be noted that these embodiments are not mutually exclusive. Components from one embodiment may be assumed to be present in another embodiment and it will be obvious to a person skilled in the art how those components may be used in the other exemplary embodiments.

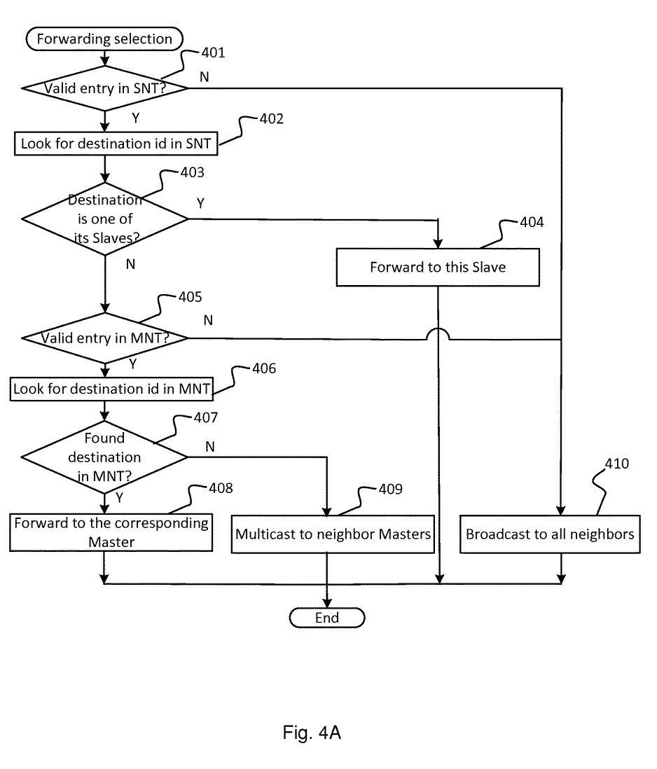

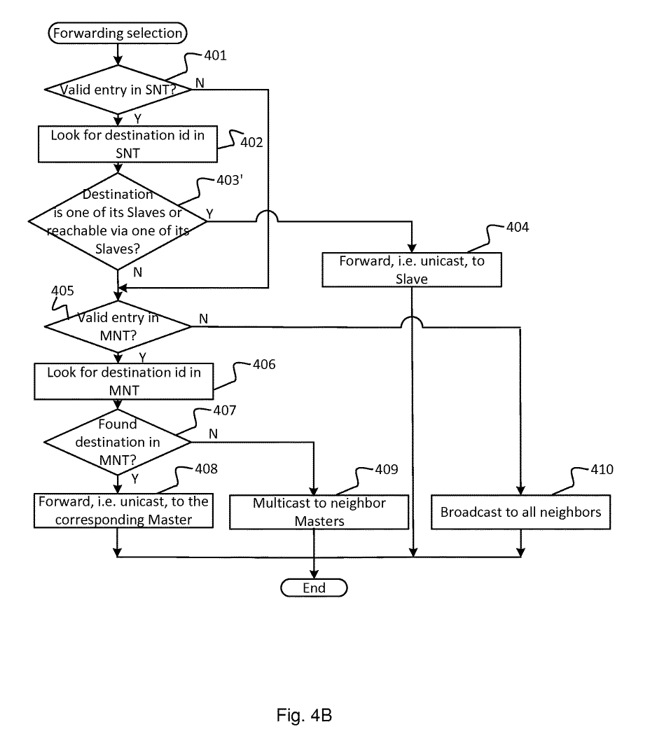

Examples of methods performed by the master device 103 for transmitting a message towards a destination node will now be described with reference to flowcharts depicted in FIGS. 4A and 4B. The master device 103 is sometimes in this disclosure 35 referred to as the third master device 103. The master device 103 and the destination node are operating in the wireless communications network 100. The master device 103 has a Slave Neighbour Table (SNT) configured to comprise information relating to a slave device 108,109,111, and a Master Neighbour Table (MNT) configured to comprise information relating to a neighbour master device 102,104 and information relating to a neighbour slave device 106,107,110 of the neighbour master device 102,104.

By the expressions “neighbour master device” and “neighbour slave device” when used in this disclosure are meant a master device and a slave device, respectively, which master and slave devices are reachable by the master device within a direct transmission range. In other words, the master device 103 is able to communicate directly with the neighbour master device 102,104 and the neighbour slave device 108,109.

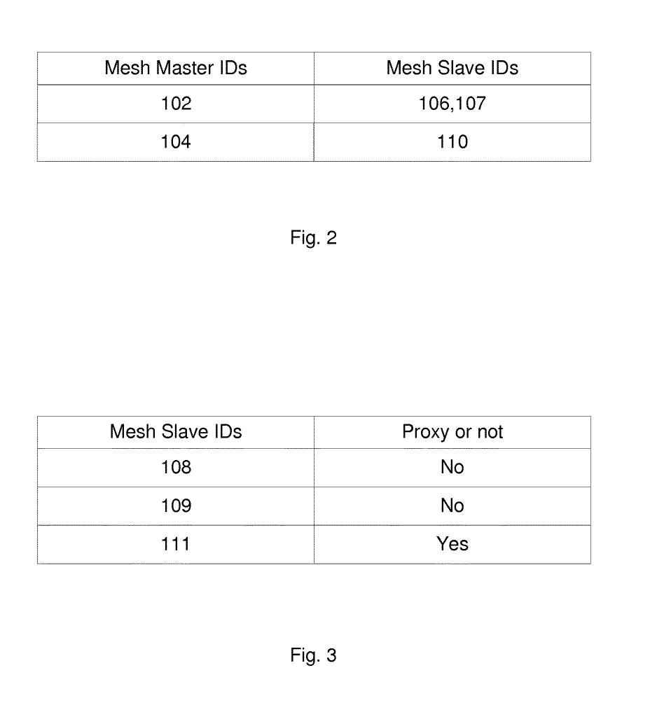

Examples of the MNT and the SNT for the master device 103 is schematically illustrated in FIGS. 2 and 3.

The communications network 100 may be a mesh network such as a Bluetooth Low Energy (BLE), mesh network.

The methods comprise one or more of the following actions. It should be understood that these actions may be taken in any suitable order and that some actions may be combined.

Action 401

The master device 103 may determine whether or not a valid entry in the SNT, e.g. in its SNT, exists. This may be done to determine whether or not the SNT comprises any entries, e.g. to determine whether or not the master device 103 has been selected as master device for a slave device.

Action 402

The master device 103 may look for the destination node's id in the SNT. That it, the master device 103 may search the SNT for the destination node's id, e.g. identity or another kind of identification of the destination node.

Action 403

The master device 103 determines if the identity of the destination node is comprised in the SNT. In other words, the master device 103 determines if the destination node is one of its slave devices.

Action 403′

Similar to Action 403, in Action 403′ of FIG. 4B, the master device 103 determines if the identity of the destination node is comprised in the SNT. Further, in Action 403′, the master device 103 determines if the destination node is reachable via one of its slave devices. For example, the latter may be the case when the destination node is reachable from the master node 103 via one of the master device's 103 slave devices acting as a proxy for the destination node. With reference to FIG. 1, if the destination node is the slave device 111, that slave device 111 is reachable for the master device 103 via its slave device 108 acting as a proxy.

Action 404

When the identity of the destination node is comprised in the SNT, the master device 103 forwards, e.g. unicasts, the message to the slave device 108,109 comprised in the SNT and having the same identity as the destination node.

In some embodiments, when the identity of the destination node is comprised in the SNT, and when the slave device 111 having the same identity as the destination node has a proxy device, the master device 102 unicasts the message to the slave device 108 acting as the proxy device.

Action 405

The master device 103 may determine whether or not a valid entry in the MNT, e.g. in its MNT, exists. This may be done to determine whether or not the MNT comprises any entries, e.g. to determine whether or not the master device 103 has knowledge about one or more neighbour master devices 102,104.

Action 406

The master device 103 may look for the destination node's id in the MNT. That it, the master device 103 may search the MNT for the destination node's id, e.g. identity or another kind of identification.

Action 407

The master device 103 determines if the identity of the destination node is comprised in the MNT. In other words, the master device 103 determines if the destination node is one of its neighbour master devices.

Action 408

When the identity of the destination node is comprised in the MNT, the master device 103 forwards, e.g. unicasts the message to the neighbour master device 102,104 having the same identity as the destination node or to the neighbour master device 102,104 being the master device of the neighbour slave device 106,107,110 having the same identity as the destination node.

Action 409

When the identity of the destination node is not comprised in the MNT, the master device 103 multicasts the message to all neighbour master devices 102,104 comprised in the MNT.

Action 410

When the identity of the destination node is neither comprised in the SNT nor in the MNT, the master device 103 broadcasts the message.

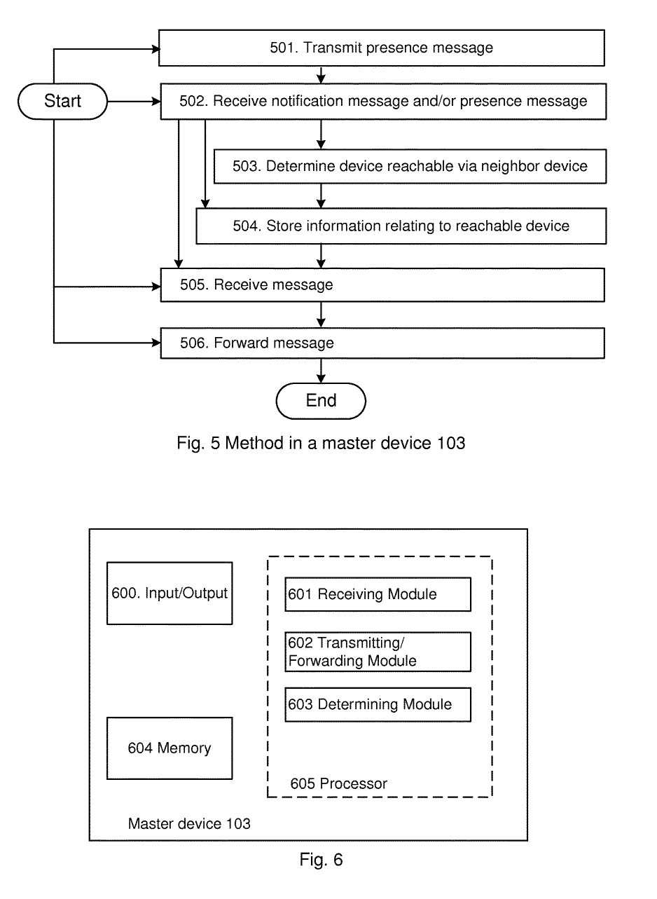

Examples of methods performed by the master device 103 for generating and/or maintaining a topology of the communications network 100 will now be described with reference to the flowchart depicted in FIG. 5. Thus, in some embodiments, the master device 103 is configured to perform one or more actions to generate and/or maintain the topology of the communications network 100.

These one or more actions will now be described with reference to FIG. 5. It should be understood that these actions may be taken in any suitable order and that some actions may be combined.

Action 501

The master device 103 transmits, to the slave device 108,109,111, a first presence message that allow the slave device 108,109,111 to select the master device 103 as its master device.

Action 502

The master device 103 receives, from the slave device 108,109,111, a notification message that notifies the master device 103 that it has been selected as master device for the slave device 108,109,111.

The master device 103 may receive the notification message in response to the transmitted first presence message.

In some embodiments, the master device 103 receives, from the neighbour master device 102,104, a second presence message that enables the master device 103 to discover the neighbour master device 102,104.

Action 503

In some embodiments, the master device 103 determines, by means of routing path optimization, an identification of the neighbour slave device 106,107,110 reachable via the neighbour master device 102,104.

Action 504

The master device 103 stores information relating to the slave device 108,109,111 in the SNT, e.g. in its SNT.

In some embodiments, when the master device 103 has received, from the neighbour master device 102,104, a second presence message that enables the master device 103 to discover the neighbour master device 102,104, as described in Action 502 above, the master device 103 stores information relating to the neighbour master device 102,104 in the MNT, e.g. in its MNT.

The master device 103 may store information relating to the neighbour master device 102,104 when a link quality of the neighbour master device 102,104 exceeds a threshold value, such as a predefined threshold value.

In some embodiments, wherein the second presence message comprises information relating to the neighbour slave device 106,107,110 reachable through the neighbour master device 102,104, the master device 103 stores information relating to the neighbour slave device 106,107,110 reachable through the neighbour master device 102,104 in the MNT, e.g. in its SNT.

In some embodiments, wherein the second presence message comprises information relating to one or more mesh devices 101,105 reachable through the neighbour master device 102,104, the master device 103 stores information relating to the one or more mesh devices 101,105 reachable through the neighbour master device 102,104 in the MNT.

Action 505

In some embodiments, the master device 103 receives a message. The message may be a mesh message received from one of its slave devices, from one neighbour master device, or from one neighbour slave device.

Action 506

The master device 103 forwards a message to one or more mesh devices comprised in the communications network 100. The message may be an original mesh data message or a received message such as a received mesh data message. Thus, the master device 103 may transmit, e.g. forward, a message that is originating from the master device 103 or a message that the master device 103 has received. The message may be forwarded to one or more master devices mentioned in the MNT, to one or more slave devices mentioned in the SNT or to one or more neighbour master devices mentioned in the MNT.

Further, it should be understood that the master device 103 may forward the message according to one or more of the Actions 401-410 described above.

As schematically illustrated in FIG. 5, some embodiments herein relate to a method in a first asymmetric device, e.g. the master device 103. The first asymmetric device, e.g. the master device, is operating in the mesh network. The master device receives one or more notification messages from one or more slave devices, and/or one or more presence messages from one or more neighbor master devices. This is schematically illustrated in action 501.

In some embodiments, the master device 103 performs routing path optimization in order to determine the identity of the devices which are reachable via a neighbor master device. This is schematically illustrated in action 502.

The master device 103 receives a message, e.g. a data message, and forwards the received message to one of its one or more slave devices, or to one or more of its one or more neighbor master devices. This is schematically illustrated in actions 503 and 504.

To perform the method for transmitting a message towards the destination node, the master device 103 may be configured according to an arrangement depicted in FIG. 6. As previously described, the master device 103 and the destination node are operating in the wireless communications network 100. For example, the communications network 100 may be a mesh network such as a BLE mesh network.

The master device 103 has the SNT configured to comprise information relating to a slave device 108,109,111, and the MNT configured to comprise information relating to a neighbour master device 102,104 and information relating to a neighbour slave device 106,107,110 of the neighbour master device 102,104.

Some embodiments herein relate to a first asymmetric device, cf. FIG. 6, comprising means configured to perform one or more actions described herein.

Embodiments herein comprise one or more other modules configured to realise features and to perform actions described herein.

For example, and according to some embodiments, cf. e.g. FIG. 6, the master device comprises means configured to perform one or more of the actions described herein. For example, the master device may comprise an input/output interface 600, a receiving module 601, a transmitting/forwarding module 602 and a determining module 603 configured to realise actions described herein or parts thereof.

The input and/or output interface 600 is configured to communicate with one or more slave devices 105-112, and one or more other master devices 101-102, 104. The input and/or output interface 600 may comprise a wireless receiver (not shown) and a wireless transmitter (not shown).

The master device 103 is configured to receive, by means of a receiving module 601 configured to receive, transmissions, e.g. one or more messages, from one or more slave device 105-112, or one or more master device 101-102, 104. The receiving module 601 may be implemented by or arranged in communication with a processor 605 of the master device 103. The processor 505 will be described in more detail below.

In some embodiments, the master device 103 is configured to receive, from the slave device 108,109,111, a notification message that notifies the master device 103 that it has been selected as master device for the slave device 108,109,111.

The master device 103 may further be configured to receive, from the neighbour master device 102,104, a second presence message that enables the master device 103 to discover the neighbour master device 102,104.

The master device 103 is configured to transmit, by means of a transmitting module 602 configured to transmit, to one or more slave devices and/or to one or more master devices 101-102,104, the message. The transmitting module 602 may be implemented by or arranged in communication with the processor 605 of the master device 103.

The transmitting module 602 is sometimes herein referred to as a forwarding module configured to forward the message to one or more slave devices and/or to one or more master devices 101-102,104.

In some embodiments, the master device 103 is configured to transmit, to the slave device 108,109,111, the first presence message that allow the slave device 108,109,111 to select the master device 103 as its master device.

When the identity of the destination node is comprised in the SNT, the master device 103 is configured to unicast the message to the slave device 108,109 comprised in the SNT and having the same identity as the destination node.

In some embodiments, when the identity of the destination node is comprised in the SNT and when the slave device 111 having the same identity as the destination node has a proxy device, the master device 103 is configured to unicast the message to the slave device 108 acting as the proxy device.

Further, when the identity of the destination node is comprised in the MNT, the master device 103 is configured to unicast the message to the neighbour master device 102,104 having the same identity as the destination node or to the neighbour master device 102,104 being the master device of the neighbour slave device 106,107,110 having the same identity as the destination node. If the identity of the destination node is not comprised in the MNT, the master device 103 is configured to multicast the message to all neighbour master devices 102,104 comprised in the MNT.

Furthermore, when the identity of the destination node is neither comprised in the SNT nor in the MNT, the master device 103 is configured to broadcast the message.

The master device 103 is configured to determine, by means of a determining module 603 configured to determine, if an identity of the destination node is comprised in the SNT. The determining module 603 may be implemented by or arranged in communication with the processor 605 of the master device 103.

Further, the master device is configured to determine if the identity of the destination node is in the MNT.

In some embodiments, the master device 103 is configured to determine, by means of routing path optimization, an identification of the neighbour slave device 106,107,110 reachable via the neighbour master device (102,104.

Further, as schematically illustrated in FIG. 6, embodiments herein may be implemented through one or more processors, such as the processor 605 in the master device 101-104, together with computer program code for performing the functions and actions of the embodiments herein. The program code may be implemented in one or several network nodes. The program code mentioned above may also be provided as a computer program product, for instance in the form of a data carrier carrying computer program code for performing the embodiments herein when being loaded into the wireless device, or the network node, e.g. the master device. One such carrier may be in the form of a CD ROM disc. It is however feasible with other data carriers such as a memory stick. The computer program code may furthermore be provided as pure program code on a server and downloaded to the wireless device, the radio network node or the network node, e.g. the master device.

The master device 101-104 may further comprise the memory 604 comprising one or more memory units. The memory is arranged to be used to store obtained information, store data, configurations, schedulings, and applications etc. to perform the methods herein when being executed in the master device.

In some embodiments, the master device 103 is configured to store information relating to the slave device 108,109,111 in the SNT.

Further, the master device 103 may be configured to store information relating to the neighbour master device 102,104 in the MNT.

In some embodiments, the master device 103 is configured to store the information relating to the neighbour master device 102,104 by further being configured to store information relating to the neighbour master device 102,104 when a link quality of the neighbour master device 102,104 exceeds a threshold value, such as a predefined threshold value.

When the second presence message further comprises information relating to the neighbour slave device 106,107,110 reachable through the neighbour master device 102,104, the master device 103 may be configured to store the information relating to the neighbour master device 102,104 by further being configured to store information relating to the neighbour slave device 106,107,110 reachable through the neighbour master device 102,104 in the MNT.

When the second presence message further comprises information relating to the neighbour slave device 106,107,110 reachable through the neighbour master device 102,104, the master device 103 may be configured to store the information relating to the neighbour master device 102,104 by further being configured to store information relating to the neighbour slave device 106,107,110 reachable through the neighbour master device 102,104 in the MNT.

Further, when the second presence message further comprises information relating to one or more mesh devices 101,105 reachable through the neighbour master device 102,104, the master device 103 may be configured to store the information relating to the neighbour master device 102,104 by further being configured to store information relating to the one or more mesh devices 101,105 reachable through the neighbour master device 102,104 in the MNT.

Mesh Topology Generation and Maintenance

A master device 101-104 periodically broadcasts a presence message to allow devices to join in its piconet. A slave device 105-111 replies to a selected master device 101-104 with one or more notification messages. Thereby, the topology is generated and maintained in one or more piconets, e.g. in one or more intra-piconets and/or in one or more inter-piconets. The out-of-piconet device 112 does not participate in the procedure unless it becomes a slave device 105-111 or a master device 101-104.

This relates to Action 501 described above, wherein the master device, e.g. the master device 103, transmits a presence message, and to Action 502 described above wherein the master device 103 receives the notification message.

1) Slave Device 105-111

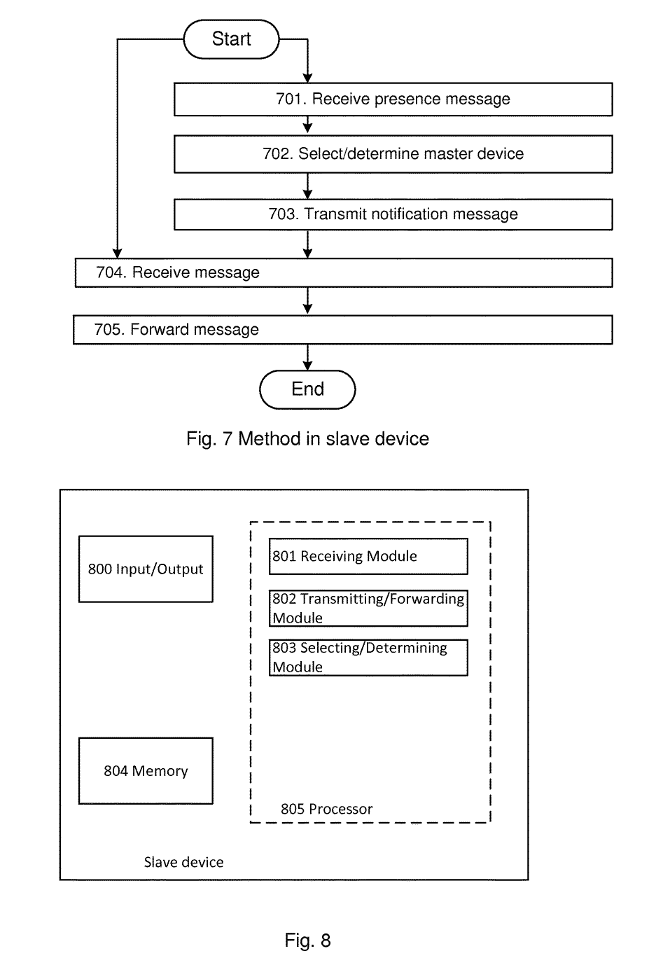

Upon receiving presence messages from one or more master devices 101-104, a slave device 105-111 may choose one of the master devices 101-104 as its master device 101-104. The slave device 105-111 may select the master device 101-104 with the best link quality, e.g. with a link quality above a certain threshold value, as its master device 101-104. For example, the first slave device 105 may select the first master device 101 as its master device, and the second and third slave devices 106,107 may select the second master device 102 as their master device. The slave device 105-111 may send a notification message to its master device 101-104 about the selection result. This relates to Actions 701-703 schematically illustrated in FIG. 7 which will be described in more detail below. FIG. 7 schematically illustrates embodiments of a method performed by the second asymmetric device e.g. the slave device 105-111, are exemplified.

As schematically illustrated in FIG. 7, some embodiments herein relate to a method in a second asymmetric device, e.g. the slave device. The second asymmetric device operates in the mesh network.

The slave device receives a presence message from one or more master devices, and selects one of the master devices as its master device. This is schematically illustrated in actions 701 and 702. The selection may be based on link quality, e.g. the master device with the best link quality may be selected. Further, the slave device sends a notification message to its master device. This is schematically illustrated in action 703.

In some embodiments, the slave device is served by another slave device, acting as a proxy device for the slave device. The slave device may have overheard the proxy device's notification message to its master device, whereupon the slave device sends a notification message to the proxy device's master device. This is schematically illustrated in action 703.

When receiving a message, e.g. a data message, for which the slave device is not the destination, the slave device forwards the received message, e.g. the received data message, to its master device or to the proxy device. This is schematically illustrated in actions 704 and 705.

In case the master device and/or the proxy device are unavailable or unreachable, the slave device forwards, e.g. by broadcasting, the message to all neighbor devices.

2) Served Slave Device 111 Served by at Least One Proxy Slave Device 108

A served slave device 111 selects at least one proxy slave device 108 after overhearing the slave device's 108 notification message, which the slave device 108 transmits to its master device 103. Then it requests a registration in the slave device's 108 master device(s) 103 by sending its notification message to the master device(s) 103. In other words, by sending its notification message to the master device 103, the master device 103 will add the served slave device 111 to the SNT as is illustrated in FIG. 3 and as will be described below. Further, in the SNT, the master device 103 will add that the served slave device 111 is reachable via a proxy, cf. FIG. 3.

3) Master Device 101-104

Each Master device 101-104 collects or receives one or more notification messages from one or more slave devices 105-111 and stores information relating to these slave devices 105-111. This relates to Actions 502-504 previously described. For example, the master device 101-104 may insert information relating to these slave devices 105-111 into a Slave Neighbour Table (SNT). However, it should be understood that the master device 101-104 may store or associate information relating to the slave devices 105-111 in another suitable way, e.g. in a memory, e.g. in a database. Thus, when reference is made to the SNT herein it should be understood as just an example of a way of storing the information. The information may be information relating to the identity of the slave device 105-111.

Upon receiving presence messages from neighbour master devices, e.g. master devices 102-104, the master device, e.g. the first master device 101, may store information relating to the other master devices 102-104 with a link quality exceeding a certain, e.g. a predefined, threshold value. For example, the first master device 101 may insert information relating to the other master devices 102-104 with a link quality exceeding a certain threshold value into a Master Neighbour Table (MNT). However, it should be understood that the master device 101-104 may store or associate information relating to one or more neighbour master devices in another suitable way, e.g. in a memory, e.g. in a database. Thus, when reference is made to the MNT herein it should be understood as just an example of a way of storing the information. The information may be information relating to the identity of the master device.

Further, a presence message from a Master device 101-104 comprises the information relating to the identifications of devices, e.g. slave devices 105-111, which may be reached through that master device 101-104. These identifications are obtained by routing path optimization, whereby an optimal path for a message being transmitted from a source node to a destination node is determined. This may be performed by means of routing path optimization algorithms. The identifications may be inserted in the corresponding entry in a MNT when a master device 101-104 receives presence messages from neighbour master devices 101-104. For example, as schematically illustrated in FIG. 1, the slave devices 106,107 of the second master device 102 may be reached by the third master device 103 which may be seen as the master device of the second master device 102. In other words, the third master device 103 may reach the slave devices 106,107 via the second master device 102. In such scenarios, the second master device 102 may be referred to as a source master device. As another example, the slave device 110 of the fourth master device 104 may be reached by the third master device 103. Exemplary embodiments of the MNT and SNT of the master device 103 are shown in FIG. 2 and FIG. 3, respectively.

This relates to Actions 502-504 previously described.

Hybrid Forwarding Scheme

As previously mentioned, embodiments herein propose a forwarding scheme with an aim to utilize the advantages of flooding with damming methods and routing path optimization. The forwarding method of the routing path optimization is mainly performed in a stationary device, e.g. in a stationary master device and/or a stationary slave device. The flooding forwarding method is performed associating with a device in motion, e.g. in a mobile slave device and/or in a mobile out-of-piconet device, and when the optimized routing paths are not feasible. Multiple optimal paths are recommended to be provided by routing path optimization algorithms when only stationary slave devices (with a low duty circling) may be selected in the path(s), in order to improve reliability and/or achievability.

Flooding with damming methods does not need time for adapting topology change due to devices in motion, which is a big challenge for routing path optimization algorithms. Thus, in some embodiments herein, a message transmitted in the network, e.g. a mesh message, shall be forwarded using flooding if the destination node has a mobility feature, e.g. the destination node is a mobile node.

Some embodiments of forwarding methods for slave devices, master devices and out-of-piconet devices when the destination node has a stationary feature, e.g. the destination node is a stationary node, will be exemplified below.

1) Slave Device 105-111

According to some embodiments herein, there are two forwarding methods for a slave device 105-111. In some embodiments, the slave device 105-111 sends a message, e.g. an original mesh data message, or forwards a received message, e.g. a received mesh data message, to its Master device 101-104 and/or Proxy device(s) 108 if it has an available master device 101-104 and/or proxy device(s) 108 and if it is not the destination, e.g. the destination node, for the message. In other words, the slave device 105-111 may unicast the message, e.g. the original mesh data message, or may unicast the received message, e.g. the received mesh data message, to its Master device 101-104 and/or Proxy device(s) 108 if it has an available master device 101-104 and/or proxy device(s) 108 and if it is not the destination, e.g. the destination node, for the message. If its master device or proxy device is temporally unreachable, the slave device shall broadcast the mesh data message to all its neighbour devices. The former forwarding method may have a higher priority.

2) Master Device 101-104

In some embodiments, a master device 101-104 sends a message, e.g. an original mesh data message, or forwards a received message, e.g. a received mesh data message, to one of its slave devices 105-111 mentioned in the SNT, to one or more Master devices 101-104 mentioned in its MNT or to one or more neighbour Master devices 101-104 mentioned in the MNT. In other words, a master device 101-104 may unicast a message, e.g. an original mesh data message, or may unicast a received message, e.g. a received mesh data message, to one of its slave devices 105-111 mentioned in the SNT. Further, the master device 101-104 may unicast or multicast the message to one or more Master devices 101-104 mentioned in its MNT or to one or more neighbour Master devices 101-104 mentioned in the MNT.

Exemplifying forwarding methods for the master device 101-104 are schematically illustrated in the FIGS. 4A and 4B. In FIGS. 4A and 4B the forwarding to slave, forwarding to corresponding master, multicasting to neighbour masters, and broadcasting to all neighbours are schematically illustrated from a possible highest priority to a possible lowest priority. As schematically illustrated and in some embodiments, the master device 101-104 may first look for the destination, e.g. the destination node, of a received message, e.g. a received mesh data message, in its SNT. This relates to Actions 401 and 402 previously described. If the destination exists in the SNT, the master device 101-104 forwards the message to the slave device 105-111 being the destination. This relates to Actions 403, 403′ and 404 previously described. Otherwise, the master device 101-104 checks if there is a valid entry in its MNT. This relates to Actions 405 previously described. If so and the destination is one of the neighbour master devices 101-104 mentioned in the MNT or a slave device 105-111 of a neighbour master device 101-104 mentioned in the MNT, the master device 101-104 forwards the message to the neighbour master device 101-104. This relates to Actions 406-408 previously described. If the master device 101-104 is not able to find the destination in the MNT, it may multicast the received message, e.g. the received mesh data message, to the all neighbour master devices 101-104 mentioned in its MNT. This relates to Actions 406-407 and 409 previously described. If the master device 101-104 is not able to find any valid neighbour master device 101-104, it may broadcast the message, e.g. the mesh data message, to all of its neighbour devices, e.g. to all neighbour master devices, to all neighbour slave devices, and to all out-of-piconet devices. This relates to Action 410 previously described.

3) Out-of-Piconet Device 112

In some embodiments, an out-of-piconet device 112 broadcasts the message, e.g. a mesh data message, to all its neighbour devices, e.g. to all neighbour master devices, to all neighbour slave devices, and to all out-of-piconet devices.

Implementation Channels

As mentioned, advertisement channels and data channels are supported by the existing BLE specifications. Some embodiments described herein may be implemented in one or more advertisement channels only or in a combination of one or more advertising channels and one or more data channels.

Firstly, intra-piconet communication, inter-piconet communication, and communication between out-of-piconet devices and piconet may be implemented in advertisement channels only. An advantage with such an implementation is that it is no need for establishing and maintaining a complex connection procedure. However, it may increase network congestion and interference due to constrained bandwidth.

Secondly, a combination of one or more advertisement channels and one or more data channel may be used. For example, an intra-piconet communication between a master device and one or more slave devices (not including Proxy devices) may be implemented in data channels, while other communications may be conducted in advertisement channels. Timers at a Master device or occupancy sensors may be used to trigger a connection creation and an establishment between the master and its slave device(s).

Furthermore, some embodiments herein relate to a second asymmetric device, e.g. the slave device 105-111, cf. FIG. 8, comprising means configured to perform one or more actions described herein.

Embodiments herein comprise one or more other modules configured to realise features and to perform actions described herein.

For example, and according to some embodiments, cf. e.g. FIG. 8, the slave device comprises means configured to perform one or more of the actions described herein. For example, the slave device may comprise an input/output interface 800, a receiving module 801, a transmitting/forwarding module 802 and a determining/selecting module 803 configured to realise actions described herein or parts thereof.

As schematically illustrated in FIG. 8, the embodiments herein may be implemented through one or more processors, such as a processor 805 in the slave device 105-111, together with computer program code for performing the functions and actions of the embodiments herein. The program code may be implemented in one or several network nodes. The program code mentioned above may also be provided as a computer program product, for instance in the form of a data carrier carrying computer program code for performing the embodiments herein when being loaded into wireless device, or the network node, e.g. the slave device. One such carrier may be in the form of a CD ROM disc. It is however feasible with other data carriers such as a memory stick. The computer program code may furthermore be provided as pure program code on a server and downloaded to the wireless device, the radio network node or the network node, e.g. the slave device.

The slave device 105-111 may further comprise a memory 804 comprising one or more memory units. The memory is arranged to be used to store obtained information, store data, configurations, schedulings, and applications etc. to perform the methods herein when being executed in the slave device.

Those skilled in the art will also appreciate that embodiments herein comprises one or more modules to realize features and functions and to perform actions described herein. The modules may refer to a combination of analog and digital circuits, and/or one or more processors configured with software and/or firmware, e.g. stored in the memory, that when executed by the one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

When using the word “comprise” or “comprising” it shall be interpreted as non-limiting, i.e. meaning “consist at least of”. Further, the word “a” or “an” should be understood to refer to “at least one” or to “one or more” if not explicitly stated that it refers to a “single” entity.

The embodiments herein are not limited to the above described preferred embodiments. Various alternatives, modifications and equivalents may be used.

1-22. (canceled)

23. A method performed by a master device for transmitting a message towards a destination node, wherein the master device and the destination node are operating in a wireless communications network, wherein the master device has a Slave Neighbor Table (SNT) comprising information relating to a slave device, and a Master Neighbor Table (MNT) comprising information relating to a neighbor master device and information relating to a neighbor slave device of the neighbor master device, and wherein the method comprises:
determining if an identity of the destination node is comprised in the SNT;
when the identity of the destination node is comprised in the SNT, unicasting the message to the slave device comprised in the SNT and having the same identity as the destination node, otherwise determining if the identity of the destination node is in the MNT;
when the identity of the destination node is comprised in the MNT, unicasting the message to the neighbor master device having the same identity as the destination node or to the neighbor master device being the master device of the neighbor slave device having the same identity as the destination node, and otherwise multicasting the message to all neighbor master devices comprised in the MNT; and
when the identity of the destination node is neither comprised in the SNT nor in the MNT, broadcasting the message.

24. The method of claim 23, wherein the unicasting of the message to the slave device comprises:
when the identity of the destination node is comprised in the SNT, and when the slave device having the same identity as the destination node has a proxy device, unicasting the message to the slave device acting as the proxy device.

25. The method of claim 23, wherein the communications network is a mesh network such as a Bluetooth Low Energy (BLE) mesh network.

26. The method of claim 23, further comprising:
transmitting, to the slave device, a first presence message that allow the slave device to select the master device as its master device.

27. The method of claim 23, further comprising:
receiving, from the slave device, a notification message that notifies the master device that it has been selected as master device for the slave device; and
storing information relating to the slave device in the SNT.

28. The method of claim 23, further comprising:
receiving, from the neighbor master device, a second presence message that enables the master device to discover the neighbor master device; and
storing information relating to the neighbor master device in the MNT.

29. The method of claim 28, wherein the storing of information relating to the neighbor master device, comprises:
storing information relating to the neighbor master device when a link quality of the neighbor master device exceeds a threshold value, such as a predefined threshold value.

30. The method of claim 28, further comprising:
determining, by means of routing path optimization, an identification of the neighbor slave device reachable via the neighbor master device.

31. The method of claim 28, wherein the second presence message further comprises information relating to the neighbor slave device reachable through the neighbor master device, and wherein the storing of information relating to the neighbor master device comprises:
storing information relating to the neighbor slave device reachable through the neighbor master device in the MNT.

32. The method of claim 28, wherein the second presence message further comprises information relating to one or more mesh devices reachable through the neighbor master device, and wherein the storing of information relating to the neighbor master device comprises:
storing information relating to the one or more mesh devices reachable through the neighbor master device in the MNT.

33. A master device for transmitting a message towards a destination node, wherein the master device and the destination node are operating in a wireless communications network, wherein the master device has a Slave Neighbor Table (SNT) comprising information relating to a slave device, and a Master Neighbor Table (MNT) comprising information relating to a neighbor master device and information relating to a neighbor slave device of the neighbor master device, and wherein the master device is configured to:
determine if an identity of the destination node is comprised in the SNT;
when the identity of the destination node is comprised in the SNT, unicast the message to the slave device comprised in the SNT and having the same identity as the destination node, and otherwise determine if the identity of the destination node is in the MNT;
when the identity of the destination node is comprised in the MNT, unicast the message to the neighbor master device having the same identity as the destination node or to the neighbor master device being the master device of the neighbor slave device having the same identity as the destination node, and otherwise multicast the message to all neighbor master devices comprised in the MNT; and
when the identity of the destination node is neither comprised in the SNT nor in the MNT, broadcast the message.

34. The master device of claim 33, wherein the master device is configured to unicast the message to the slave device comprised in the SNT by being configured to:
when the identity of the destination node is comprised in the SNT, and when the slave device having the same identity as the destination node has a proxy device, unicast the message to the slave device acting as the proxy device.

35. The master device of claim 33, wherein the communications network is a mesh network such as a Bluetooth Low Energy (BLE) mesh network.

36. The master device of claim 33, further being configured to:
transmit, to the slave device, a first presence message that allow the slave device to select the master device as its master device.

37. The master device of claim 33, further being configured to:
receive, from the slave device, a notification message that notifies the master device that it has been selected as master device for the slave device; and
store information relating to the slave device in the SNT.

38. The master device of claim 33, further being configured to:
receive, from the neighbor master device, a second presence message that enables the master device to discover the neighbor master device; and
store information relating to the neighbor master device in the MNT.

39. The master device of claim 37, wherein the master device is configured to store the information relating to the neighbor master device by further being configured to:
store information relating to the neighbor master device when a link quality of the neighbor master device exceeds a threshold value, such as a predefined threshold value.

40. The master device of claim 37, further being configured to:
determine, by means of routing path optimization, an identification of the neighbor slave device reachable via the neighbor master device.

41. The master device of claim 37, wherein the second presence message further comprises information relating to the neighbor slave device reachable through the neighbor master device, and wherein the master device is configured to store the information relating to the neighbor master device by further being configured to:
store information relating to the neighbor slave device reachable through the neighbor master device in the MNT.

42. The master device of claim 37, wherein the second presence message further comprises information relating to one or more mesh devices reachable through the neighbor master device, and wherein the master device is configured to store the information relating to the neighbor master device by further being configured to:
store information relating to the one or more mesh devices reachable through the neighbor master device in the MNT.

43. A non-transitory computer-readable medium storing a computer program comprising program instructions that, when executed on at least one processor of a master device, configures the master device for transmitting a message towards a destination node, wherein the master device and the destination node are operating in a wireless communications network, wherein the master device has a Slave Neighbor Table (SNT) comprising information relating to a slave device, and a Master Neighbor Table (MNT) comprising information relating to a neighbor master device and information relating to a neighbor slave device of the neighbor master device, said computer program comprising program instructions configuring the master device to:
determine if an identity of the destination node is comprised in the SNT;
when the identity of the destination node is comprised in the SNT, unicast the message to the slave device comprised in the SNT and having the same identity as the destination node, otherwise determine if the identity of the destination node is in the MNT;
when the identity of the destination node is comprised in the MNT, unicast the message to the neighbor master device having the same identity as the destination node or to the neighbor master device being the master device of the neighbor slave device having the same identity as the destination node, and otherwise multicast the message to all neighbor master devices comprised in the MNT; and
when the identity of the destination node is neither comprised in the SNT nor in the MNT, broadcast the message.
